(19) United States
(12) Patent Application Publication
(10) Pub. No.: US 2026/0302197 A1
(43) Pub. Date: Oct. 1, 2026

(54) ANODE ACTIVE MATERIAL LAYER AND SOLID-STATE BATTERY

(71) Applicant: TOYOTA JIDOSHA KABUSHIKI KAISHA, Toyota-shi (JP)

(72) Inventors: Sakina KAJITA KANEKO, Fujisawa-shi (JP); Ryo ASAKURA, Sunto-gun (JP); Shinya SHIOTANI, Nagoya-shi (JP); Tomoya MATSUNAGA, Susono-shi (JP)

(73) Assignee: TOYOTA JIDOSHA KABUSHIKI KAISHA, Toyota-shi (JP)

(21) Appl. No.: 19/462,195

(22) Filed: Jan. 28, 2026

(30) Foreign Application Priority Data
Apr. 1, 2025 (JP) 2025-060698

(51) Int. Cl. H01M 4/40; H01M 4/02; H01M 4/134; H01M 10/0525

(52) U.S. Cl. CPC H01M 4/405; H01M 4/134; H01M 2004/027; H01M 10/0525

(57) ABSTRACT

The anode active material layer of the present disclosure includes a lithium alloy represented by the general formula Li—X at a depth of discharge of 80%, where X is Mg, Ag, or a combination thereof. In the anode active material layer of the present disclosure, Li in the lithium alloy has a crystallinity of 8.0% or less, as determined by XRD analysis. The crystallinity is defined by Equation (1): scattering intensity from crystalline phase/(scattering intensity from crystalline phase+scattering intensity from amorphous phase). The solid-state battery of the present disclosure includes the anode active material layer of the present disclosure, a solid electrolyte layer, and a cathode active material layer in this order.

### CROSS-REFERENCE TO RELATED APPLICATION

This application claims priority to Japanese Patent Application No. 2025-060698 filed on Apr. 1, 2025. The disclosure of the above-identified application, including the specification, drawings, and claims, is incorporated by reference herein in its entirety.

### BACKGROUND

### 1. Technical Field

The present disclosure relates to anode active material layers and solid-state batteries.

### 2. Description of Related Art

As disclosed in Japanese Unexamined Patent Application Publication Nos. 2020-184407 (JP 2020-184407 A) and 2024-141459 (JP 2024-141459 A), anode active material layers containing lithium alloys are known in the art.

### SUMMARY

The inventors have found that batteries having an anode active material layer containing a lithium alloy still have room for improvement in discharge-rate performance.

An object of the present disclosure is to provide an anode active material layer capable of improving discharge-rate performance of a battery, and a solid-state battery including such an anode active material layer.

The inventors have found that the above issue can be addressed by the following means.

### First Aspect

An anode active material layer including a lithium alloy represented by a general formula Li—X at a depth of discharge of 80%, where X is Mg, Ag, or a combination of Mg and Ag, wherein Li in the lithium alloy has a crystallinity of 8.0% or less, as determined by X-ray diffraction (XRD) analysis, the crystallinity being defined by Equation (1):

scattering intensity from crystalline phase/(scattering intensity from crystalline phase+scattering intensity from amorphous phase) (1).

### Second Aspect

The anode active material layer according to the first aspect, wherein X in the general formula is Mg.

### Third Aspect

The anode active material layer according to the second aspect, wherein the crystallinity is 1.0% or less.

### Fourth Aspect

A solid-state battery including the anode active material layer according to any one of the first to third aspects, a solid electrolyte layer, and a cathode active material layer in an order of the anode active material layer, the solid electrolyte layer, and the cathode active material layer.

The present disclosure can provide an anode active material layer capable of improving discharge-rate performance of a battery, and a solid-state battery including such an anode active material layer.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic sectional view showing an example of a solid-state battery according to the present disclosure;

FIG. 2 shows the XRD patterns of Li in the lithium alloy in the anode active material layers of Examples 1 to 4 and Comparative Example 1 at a depth of discharge (DOD) of 80%; and

FIG. 3 is a graph showing the relationship between the crystallinity of Li in the lithium alloy in the anode active material layer and the discharge capacity ratio of the battery for Examples 1 to 4 and Comparative Example 1.

### DETAILED DESCRIPTION OF EMBODIMENTS

An embodiment of the present disclosure will be described below in detail. The present disclosure is not limited to the embodiment described below, and various modifications may be made within the scope of the present disclosure.

### Anode Active Material Layer

The anode active material layer of the present disclosure includes a lithium alloy represented by the general formula Li—X at a depth of discharge of 80%, where X is Mg, Ag, or a combination thereof. In the anode active material layer of the present disclosure, Li in the lithium alloy has a crystallinity of 8.0% or less, as determined by XRD analysis. The crystallinity is defined by Equation (1):

$$scattering intensity from crystalline phase / ( scattering intensity from crystalline phase + scattering intensity from amorphous phase ) . \qquad ( 1 )$$

The inventors found that, in an anode active material layer containing an Li—X alloy (where X is Mg, Ag, or a combination thereof), the discharge capacity decreases under high current-density conditions, such as during high-rate discharge. While not wishing to be bound by any theory, it is believed that this is due to the following mechanism. During high-rate discharge, Li dissolves at the interface between the lithium alloy and the electrolyte, and this is believed to form a layer with a high concentration of Mg and/or Ag. This layer acts as a resistive layer exhibiting a low Li-ion diffusion rate, and therefore the discharge capacity decreases during high-rate discharge. In other words, the discharge-rate performance deteriorates.

The inventors also discovered that lowering the crystallinity of Li in the lithium alloy, as determined by XRD analysis, can suppress the decrease in discharge capacity during high-rate discharge and therefore improve discharge-rate performance. While not wishing to be bound by any theory, it is believed that this is due to the following mechanism. In the amorphous phase, more Li-ion diffusion pathways are available than in the crystalline phase, and therefore Li-ion diffusivity is believed to be higher in the amorphous phase. As a result, the higher Li-ion diffusivity allows Li to be more readily supplied to the solid-electrolyte interface, thereby improving the discharge-rate performance.

The components that can constitute the anode active material layer of the present disclosure will now be described.

The anode active material layer of the present disclosure includes a lithium alloy represented by the general formula Li—X at a depth of discharge (DOD) of 80%, where X is Mg, Ag, or a combination thereof. In the anode active material layer, the lithium alloy functions as an anode active material. As used herein, the “depth of discharge” refers to the ratio of the capacity that has been discharged to the total discharge capacity of a secondary battery.

In the anode active material layer of the present disclosure, Li in the lithium alloy has a crystallinity of 8.0% or less, as determined by XRD analysis. The crystallinity is defined by Equation (1):

$$scattering intensity from crystalline phase / ( scattering intensity from crystalline phase + scattering intensity from amorphous phase ) . \qquad ( 1 )$$

Accordingly, lowering the crystallinity of Li in the lithium alloy can improve the discharge-rate performance of the battery.

In the general formula, X may be Mg or Ag, and may particularly be Mg. This effectively improves the discharge-rate performance of the battery.

The crystallinity defined by Equation (1) may be 6.0% or less, 5.0% or less, 4.0% or less, 3.0% or less, 2.0% or less, 1.0% or less, 0.8% or less, 0.6% or less, 0.5% or less, 0.4% or less, 0.3% or less, 0.2% or less, or 0.1% or less, and may particularly be 0%. This effectively improves the discharge-rate performance of the battery.

The crystallinity can be determined as follows. First, the DOD of the solid-state battery including the anode active material layer of the present disclosure is adjusted to 80%. The solid-state battery is then disassembled, and XRD measurement is performed on the surface of the anode active material layer on the anode current collector side. The XRD measurement can be performed using the powder X-ray analysis software PDXL by fitting the data over a fitting range of 5° to 40° and analyzing Li in the Li—Mg alloy. Using the resulting XRD pattern, the crystallinity can be calculated from the scattering intensity from the crystalline phase corresponding to the Li (110) peak near 36.4°, and the scattering intensity from the amorphous phase obtained from the baseline in the range of 5° to 40°.

The thickness of the anode active material layer is not particularly limited and may be 30 nm to 5000 nm, 100 nm to 3000 nm, or 500 nm to 1500 nm.

The anode active material layer of the present disclosure may contain an anode active material other than the above lithium alloy, and any optional components, or may contain none of these. The content of the lithium alloy in the anode active material layer of the present disclosure may be 50 wt % or more, 70 wt % or more, 80 wt % or more, 90 wt % or more, or 95 wt % or more, and may be 100 wt %.

### Method for Producing Anode Active Material Layer

The anode active material layer of the present disclosure can be produced by a method including:
depositing magnesium and/or silver by vacuum deposition onto the surface of an anode current collector layer or a solid electrolyte layer using an electron-beam evaporation system, thereby forming a metal layer, where the emission current of the electron-beam evaporation system is 50 mA or more;
preparing a cathode active material layer containing a lithium-containing cathode active material;
assembling a precursor battery including the anode current collector layer, the metal layer, the solid electrolyte layer, and the cathode active material layer in this order; and charging the precursor battery such that lithium alloys with the magnesium and/or silver in the metal layer.

By setting the emission current within the above range, the crystallinity of Li in the resulting lithium alloy can be reduced. The emission current may be 80 mA or more, 100 mA or more, 120 mA or more, 140 mA or more, or 150 mA or more, and may be 300 mA or less, 200 mA or less, or 150 mA or less. This enables the crystallinity of Li in the lithium alloy to be reduced more effectively.

The crystallinity of Li can also be controlled by adjusting the deposition rate.

EBX-1000C manufactured by ULVAC may be employed as the electron-beam deposition system.

To promote alloying between lithium and the magnesium and/or silver in the metal layer, the precursor battery may be subjected to multiple charge-discharge cycles. The number of charge-discharge cycles is not particularly limited and may be set as appropriate in view of factors such as the thickness of the metal layer.

Details of the anode current collector layer, the solid electrolyte layer, and the cathode active material layer can be found in the following description of the solid-state battery.

### Solid-State Battery

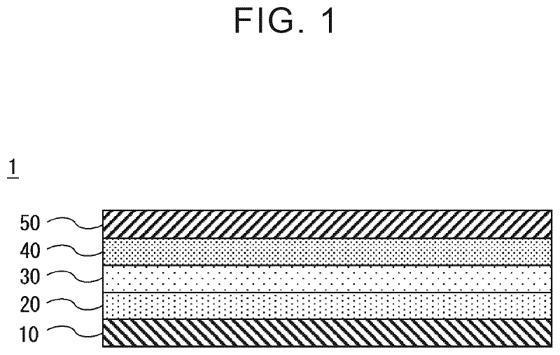

The solid-state battery of the present disclosure includes the anode active material layer of the present disclosure, a solid electrolyte layer, and a cathode active material layer in this order. As illustrated in FIG. 1, a solid-state battery 1 of the present disclosure may include an anode current collector layer 10, an anode active material layer of the present disclosure, a solid electrolyte layer 30, a cathode active material layer 40, and a cathode current collector layer 50 in this order.

In the present disclosure, the “solid-state battery” refers to a battery that contains at least a solid electrolyte as the electrolyte. Accordingly, the solid-state battery may contain a combination of a solid electrolyte and a liquid electrolyte as the electrolyte. The solid-state battery of the present disclosure may also be an all-solid-state battery, i.e., a battery that contains only a solid electrolyte as the electrolyte.

The solid-state battery of the present disclosure may be a solid secondary battery, and may particularly be a solid lithium-ion secondary battery.

The components that can constitute the solid-state battery of the present disclosure will now be described. The following illustrates an example in which the solid-state battery of the present disclosure is an all-solid-state lithium-ion secondary battery.

### Anode Current Collector Layer

The anode current collector layer may be made of a material that does not alloy with Li, and examples include stainless steel (SUS), copper, and nickel. The anode current collector layer may be, for example, in the form of a foil or a plate. The shape of the anode current collector layer in plan view may be circular, elliptical, rectangular, or polygonal. The thickness of the anode current collector layer is not particularly limited and may be, for example, 1 μm to 50 μm, or 5 μm to 20 μm.

### Anode Active Material Layer

Details of the anode active material layer can be found in the above description.

### Solid Electrolyte Layer

The solid electrolyte layer contains a solid electrolyte and may optionally contain a binder.

The thickness of the solid electrolyte layer is not particularly limited.

### Solid Electrolyte

Examples of solid electrolytes include sulfide-based solid electrolytes and oxide-based solid electrolytes.

Examples of sulfide-based solid electrolytes include Li₂S—P₂S₅, Li₂S—SiS₂, LiX—Li₂S—SiS₂, LiX—Li₂S—P₂S₅, LiX—Li₂O—Li₂S—P₂S₅, LiX—Li₂S—P₂O₅, LiX—Li₃PO₄—P₂S₅, and Li₃PS₄. The notation “Li₂S—P₂S₅” refers to a material obtained using a raw material composition containing Li₂S and P₂S₅, and the same applies to the other notations. Furthermore, “X” in LiX represents a halogen element. When a raw material composition contains LiX, it may contain one LiX compound or two or more LiX compounds. When two or more LiX compounds are present, their mixing ratio is not particularly limited.

Examples of oxide-based solid electrolytes include Li_{6.25}La₃Zr₂Al_{0.25}O₁₂, Li₃PO₄, and Li₃₊ₓPO₄₋ₓNₓ (0<x≤3).

The shape and size of the solid electrolyte are not particularly limited.

The content of the solid electrolyte in the solid electrolyte layer is not particularly limited and may be set as appropriate in view of factors such as desired ionic conducting properties.

### Binder

Examples of binders include acrylonitrile-butadiene rubber (ABR), butadiene rubber (BR), polyvinylidene fluoride (PVdF), and styrene-butadiene rubber (SBR).

The content of the binder in the solid electrolyte layer is not particularly limited and may be set as appropriate in view of factors such as desired binding properties.

### Protective Layer

Although not shown in the drawings, the solid-state battery of the present disclosure may further include a protective layer containing a metal between the anode active material layer and the solid electrolyte layer. This can suppress the interfacial resistance between the anode active material layer and the solid electrolyte layer. The metal in this protective layer is not particularly limited and may be, for example, tin.

### Cathode Active Material Layer

The cathode active material layer contains a cathode active material and may optionally contain a solid electrolyte, a conductive additive, and a binder.

The thickness of the cathode active material layer is not particularly limited.

### Cathode Active Material

Examples of cathode active materials include metallic lithium (Li); lithium alloys; LiCoO₂; LiNiₓCo₁₋ₓO₂ (0<x<1); LiNi_{1/3}Co_{1/3}Mn_{1/3}O₂; LiMnO₂; hetero-element-substituted Li— Mn spinels (e.g., LiMn_{1.5}Ni_{0.5}O₄, LiMn_{1.5}Al_{0.5}O₄, LiMn_{1.5}Mg_{0.5}O₄, LiMn_{1.5}Co_{0.5}O₄, LiMn_{1.5}Fe_{0.5}O₄, and LiMn_{1.5}Zn_{0.5}O₄); lithium titanate (e.g., Li₄TisO₁₂); lithium metal phosphates (e.g., LiFePO₄, LiMnPO₄, LiCoPO₄, and LiNiPO₄); LiCON; Li₂SiO₃; and Li₄SiO₄.

Examples of lithium alloys include Li—Au, Li—Mg, Li—Sn, Li—Si, Li—Al, Li—Ge, Li— Sb, Li— B, Li— C, Li— Ca, Li—Ga, Li—As, Li—Se, Li—Ru, Li—Rh, Li—Pd, Li—Ag, Li—Cd, Li—Ir, Li—Pt, Li—Hg, Li—Pb, Li—Bi, Li—Zn, Li—Tl, Li—Te, Li—At, and Li—In.

A coating layer containing an Li-ion-conducting oxide may be formed on the surface of the cathode active material. Examples of Li-ion-conducting oxides include LiNbO₃, Li₄Ti₅O₁₂, and Li₃PO₄.

The shape and size of the cathode active material are not particularly limited.

The content of the cathode active material in the cathode active material layer is not particularly limited and may be set as appropriate in view of factors such as desired battery capacity.

### Solid Electrolyte

Details of the solid electrolyte can be found in the above description.

The content of the solid electrolyte in the cathode active material layer is not particularly limited and may be set as appropriate in view of factors such as desired ionic conducting properties.

### Conductive Additive

The conductive additive is not particularly limited and may be, for example, a carbon material, metal particles, or a combination thereof. Examples of carbon materials include carbon black such as acetylene black and furnace black; fibrous carbon materials such as carbon nanotubes, carbon nanofibers, and vapor-grown carbon fibers; and combinations thereof. The metal particles are not particularly limited, and examples include particles of Ni, Cu, Fe, or stainless steel (SUS), and combinations thereof.

The content of the conductive additive in the cathode active material layer is not particularly limited and may be set as appropriate in view of factors such as desired electronic conducting properties.

### Binder

Details of the binder can be found in the above description.

The content of the binder in the cathode active material layer is not particularly limited and may be set as appropriate in view of factors such as desired binding properties.

### Cathode Current Collector Layer

The material for the cathode current collector layer may be any known metal that can be used as a current collector layer in solid-state batteries. Such metals include at least one metal selected from the group consisting of Cu, Ni, Al, V, Au, Pt, Mg, Fe, Ti, Co, Cr, Zn, Ge, and In. The cathode current collector layer may be, for example, in the form of a foil or a mesh. The thickness of the cathode current collector layer is not particularly limited.

### Other Configurations

The solid-state battery of the present disclosure may be configured such that the above components are housed within an outer casing. Any known outer casing used for solid-state batteries may be employed. A plurality of solid-state batteries may be electrically connected or stacked as desired to form a battery assembly. In this case, the battery assembly may be housed within a known battery case. The solid-state battery may further include other well-known components such as terminals. The solid-state battery may be, for example, in the form of a coin-type, laminate (pouch)-type, cylindrical, or prismatic battery.

### Method for Manufacturing Solid-State Battery

The solid-state battery of the present disclosure can be manufactured by a method that includes producing the anode active material layer by the method described above.

### Example 1

### Formation of Anode Active Material Layer Containing Lithium Alloy

### Deposition of Magnesium Layer

Using an electron-beam evaporation system (EBX-1000C, manufactured by ULVAC), a 1000-nm magnesium (Mg) layer was deposited onto a nickel (Ni) foil at an emission current of 150 mA to form an Mg layer. Subsequently, using the electron-beam evaporation system, a 100-nm tin (Sn) layer was deposited onto the Mg layer to form an Sn layer.

### Fabrication of Battery

As a sulfide-based solid electrolyte, 101.7 mg of an Li₂S—P₂S₅-based material containing LiBr and LiI was prepared. The sulfide-based solid electrolyte was pressed at a pressure of 6 ton/cm² to obtain a solid electrolyte layer (thickness: 500 μm). A metallic lithium (Li) foil (thickness: 150 μm) was placed on one surface of the solid electrolyte layer, and the Ni foil with the Mg and Sn layers deposited thereon was placed on the opposite surface of the solid electrolyte layer such that the Sn layer was in contact with the solid electrolyte layer. The resulting stack of layers was then press-molded at a pressure of 1 ton/cm² to obtain a battery including the Li metal foil, the solid electrolyte layer, the Sn layer, the Mg layer, and the Ni foil in this order.

### Alloying

The resulting battery was left to stand in a thermostatic chamber at 25° C. for one hour to equalize the temperature inside the battery. The battery was then charged at a constant current corresponding to a current density of 435 μA/cm². As the metallic Li foil dissolved during this charging, Li migrated through the solid electrolyte layer toward the Mg layer and alloyed with Mg in the Mg layer, thereby forming an anode active material layer containing an Li—Mg alloy. Charging was stopped when the charge capacity of the evaluation battery reached 4.35 mAh/cm². An all-solid-state battery including an anode active material layer containing an Li—Mg alloy was thus obtained.

### Examples 2 to 4 and Comparative Example 1

The anode active material layers and solid-state batteries of Examples 2 to 4 and Comparative Example 1 were prepared in the same manner as Example 1, except that the emission current value of the electron-beam evaporation system was changed as shown in Table 1.

### Crystallinity

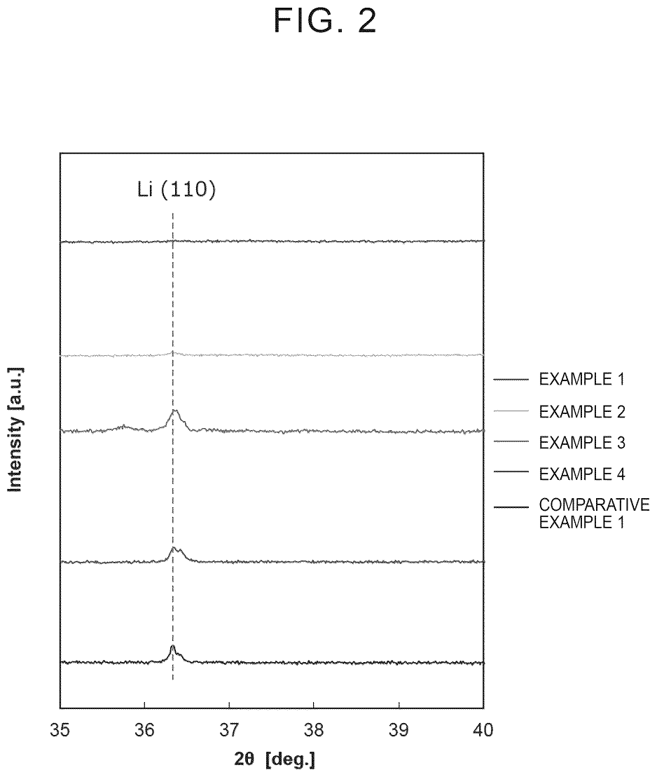

After each of the all-solid-state batteries of Examples 1 to 4 and Comparative Example 1 was adjusted to a DOD of 80%, each all-solid-state battery was disassembled and XRD measurement was performed on the surface of the anode active material layer on the Ni current collector foil side. The XRD measurement was performed using the powder X-ray analysis software PDXL by fitting the data over a fitting range of 5° to 40° and analyzing Li in the Li—Mg alloy. The obtained XRD patterns are shown in FIG. 2. Using each of the XRD patterns shown in FIG. 2, the crystallinity was calculated from the scattering intensity from the crystalline phase corresponding to the Li (110) peak near 36.4°, and the scattering intensity from the amorphous phase obtained from the baseline in the range of 5° to 40°. The results are shown in Table 1.

### Discharge Capacity Ratio

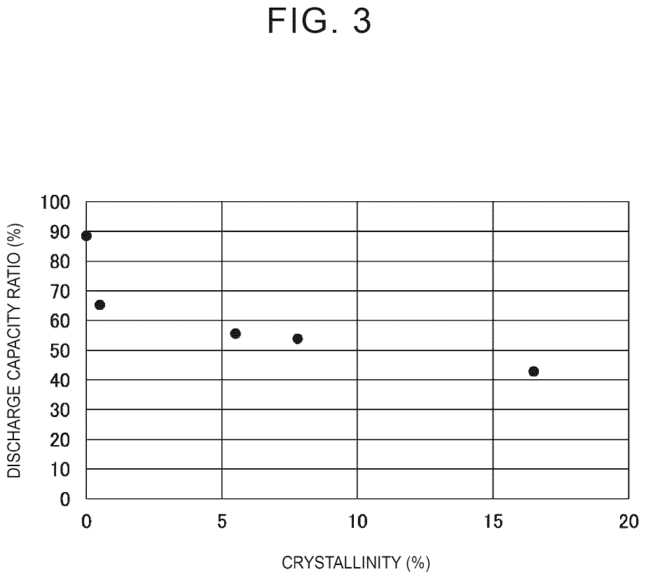

The discharge capacity ratios of the all-solid-state batteries of Examples 1 to 4 and Comparative Example 1 when discharged under predetermined conditions are shown in Table 1 and FIG. 3. The term “discharge capacity ratio” refers to the discharge capacity at 1C divided by the discharge capacity at 0.2C.

TABLE 1

| | | | Discharge |
|---|---|---|---|
| | Emission | | Capacity |
| | Current | Crystallinity | Ratio |
| | (mA) | (%) | (%) |
| Example 1 | 150 | 0 | 88.4 |
| Example 2 | 100 | 0.5 | 65.2 |
| Example 3 | 80 | 5.5 | 55.5 |
| Example 4 | 50 | 7.8 | 53.8 |
| Comparative | 30 | 16.5 | 42.8 |
| Example 1 | | | |

As shown in Table 1 and FIG. 3, the batteries in which the crystallinity of Li in the lithium alloy was 8.0% or less, as determined by XRD analysis, exhibited higher discharge-capacity ratios. In particular, the lower the crystallinity, the higher the discharge-capacity ratio.

What is claimed is:

1. An anode active material layer comprising a lithium alloy represented by a general formula Li—X at a depth of discharge of 80%, where X is Mg, Ag, or a combination of Mg and Ag,
wherein Li in the lithium alloy has a crystallinity of 8.0% or less, as determined by X-ray diffraction analysis, the crystallinity being defined by Equation (1):
scattering intensity from crystalline phase/(scattering intensity from crystalline phase+scattering intensity from amorphous phase) (1).

2. The anode active material layer according to claim 1, wherein X in the general formula is Mg.

3. The anode active material layer according to claim 2, wherein the crystallinity is 1.0% or less.

4. A solid-state battery comprising the anode active material layer according to claim 1, a solid electrolyte layer, and a cathode active material layer in an order of the anode active material layer, the solid electrolyte layer, and the cathode active material layer.
